(19) United States
(12) Patent Application Publication
(10) Pub. No.: US 2011/0286147 A1
(43) Pub. Date: Nov. 24, 2011

(54) ELECTRODE MATERIAL AND CAPACITOR

(75) Inventors: Yongsheng Chen, Tianjin (CN); Yi Huang, Tianjin (CN); Yan Wang, Tianjin (CN); Yanfeng Ma, Tianjin (CN)

(73) Assignees: TIANJIN PULAN NANO TECHNOLOGY CO., LTD., Tianjin (CN); NANKAI UNIVERSITY, Tianjin (CN)

(21) Appl. No.: 13/125,752

(22) PCT Filed: Oct. 26, 2009
(86) PCT No.: PCT/CN09/74620

§ 371 Date: Jul. 28, 2011

(30) Foreign Application Priority Data
Oct. 24, 2008 (CN) 200810152470.4

(51) Int. Cl. H01B 1/04; H01G 9/00; H01B 1/24; H01G 2/00

(52) U.S. Cl. 361/500; 361/271; 252/502; 252/511

(57) ABSTRACT

An electrode material comprising 0.5-50 wt % functionalized graphene material and a capacitor comprising the electrode material are provided. A method for preparing the functionalized graphene material is also provided. The method comprises the step of chemically reducing the soluble graphene material and the step of physically reducing the chemically reduced graphene material.

### TECHNICAL FIELD

The present application relates to an electrode material and a supercapacitor made from the material. Particularly, the present application relates to an electrode material comprising functionalized graphene material and a supercapacitor made from the material.

### BACKGROUND ART

Supercapacitors, also called electrochemical capacitors (ECs), have superior pulse performance and large energy storage capacity performance, can charge and discharge instantaneously with large current, and are novel environment-friendly energy storage devices.

Electrochemical capacitors store electric energy through formation of double electric layers or occurrence of two-dimensional or quasi-two-dimensional Faradic reaction on the electrode surface. As a novel kind of energy storage device, electrochemical capacitors catch the attention of lots of researchers for their high power and long life.

According to the electrode materials, electrochemical capacitors could be divided into the following three types: (1) carbon electrode capacitors; (2) noble metal oxide electrode capacitors; and (3) conductive polymer capacitors.

Limited resources and high cost of noble metals restrict industrial application of noble metal oxide electrode capacitors. Poor repeatability during cycling of conductive polymer capacitors also restricts their application.

In recent years, studies on carbon electrode capacitors mainly focused on increasing specific surface area of carbon materials and controlling pore size and pore size distribution thereof, thereby many different kinds of carbon materials were developed, including activated carbon powders, activated carbon fibers, carbon aerogels and carbon nanotubes, etc.

However, the above capacitors still have disadvantages. Therefore, there is still a need of electrode materials and capacitors with improved performance in industry, and thus the present application is provided.

### BRIEF DESCRIPTION OF THE INVENTION

One aspect of the present application provides an electrode material, comprising 0.5-50 wt % of a functionalized graphene material based on the total weight of the electrode material and an electrode substrate.

Another aspect of the present application provides a capacitor comprising an electrode plate comprising 2-30 wt % of a functionalized graphene material by weight of the electrode plate.

Another aspect of the present application provides a method for preparing an electrode material, comprising adhering a predetermined amount of functionalized graphene material to an electrode substrate.

Another aspect of the present application provides a method for improving performance of a capacitor electrode, comprising adhering 0.5-50 wt % of a functionalized graphene material based on weight of the whole electrode to the electrode.

In the present application, the amount of the functionalized graphene material by weight of the whole electrode material depends on the actual demand. For example, in some embodiments, the amount of the functionalized graphene material is 1-40 wt %, based on weight of the whole electrode material. In some embodiments, the amount of the functionalized graphene material is 2-30 wt %, based on weight of the electrode substrate. In some other embodiments, the amount of the functionalized graphene material is 2-30 wt %, preferably 2-30 wt %, more preferably 2-20 wt %, based on weight of the whole electrode material.

The electrode material of the present application may further comprise conductive carbon black and/or a binder. The conductive carbon black and binder may independently comprise 5-30% by weight of the added functionalized graphene material.

In the present application, the functionalized graphene material used is preferably functionalized graphene material powder.

In some embodiments of the present application, a predetermined amount of functionalized graphene material powder or its mixture in the form of powder with conductive carbon black and/or a binder can be directly pressed onto a conventional electrode substrate/electrode plate.

The supercapacitor of the present application has higher specific capacitance and energy density (up to 40 Whkg⁻¹), and its specific power can be up to 35 kWkg⁻¹.

### BRIEF DESCRIPTION OF THE DRAWINGS

FIG. 1 shows the structure of one example of a supercapacitor according to the present application.

FIG. 2 is a galvanostatic charge/discharge curve of the supercapacitor prepared in one example of the present application.

FIG. 3 is a cyclic voltammetry curve of the supercapacitor prepared in one example of the present application.

FIG. 4 is an alternating current impedance test curve of the supercapacitor prepared in one example of the present application.

FIG. 5 is a transmission electron microscope image of the soluble single-layer graphite oxide in one example of the present application.

FIG. 6 is an atomic force microscope image of the soluble single-layer graphite oxide in one example of the present application.

### DETAIL DESCRIPTION OF THE PRESENT INVENTION

### Definition

“Graphene” or “graphene material”—unless otherwise stated, the term “graphene” or “graphene material” as used in the present application refers to a two-dimensional graphite material in which the corbon atoms are present in a single layer. Thickness of the single layer is from 0.34 nm to 4 nm, and area thereof is from 10 nm² to 400 mm² (also called “single-layer graphite” due to its structure).

“Soluble graphene (material)” or “soluble graphene material”—unless otherwise stated, the term “soluble graphene (material)” or “soluble graphene material” as used in the present application refers to a graphene material having a solubility of above 0.1 mg/ml in water or an organic solvent after modification of the “graphene” or “graphene material”. The organic solvent is preferably a polar organic solvent, more preferably an organic solvent miscible with water.

“Functionalized graphene” or “functionalized graphene material”—unless otherwise stated, the term “functionalized graphene” or “functionalized graphene material” as used in the present application refers to a graphene material with higher electrical conductivity of greater than 1 S/m (conventional four-electrode test method) obtained by chemical reduction or physical reduction or a combination thereof from “soluble graphene (material)”.

“Electrode substrate”—unless otherwise stated, the term “electrode substrate” as used in the present application refers to a material that can be used in electrode production or a prepared electrode in the prior art. For example, it can be a commonly used metal electrode, such as a platinum, nickel, aluminium electrode material or a prepared electrode.

“Adhering”—unless otherwise stated, the term “adhering” as used in the present application refers to the action or state of applying the “functionalized graphene” or “functionalized graphene material” onto the electrode material surface.

Surprisingly, the inventors found that adhering a predetermined amount of functionalized graphene to an electrode material can extremely improve the electrode performance of the electrode material. Therefore, the present application firstly relates to an electrode material comprising a predetermined amount of a functionalized graphene material.

In the electrode material of the present application, the amount of the functionalized graphene material by weight of the electrode material can be determined according to the actual demand. Generally, the functionalized graphene material is 0.5-50 wt % of the whole electrode material. In some embodiments, the amount is 1-40 wt %. In some embodiments, the amount is 2-30 wt %. In some other embodiments, the amount is preferably 2-20 wt % of the whole electrode material.

In some embodiments, the electrode material of the present application may further comprise 5-30 wt % of conductive carbon black, based on the functionalized graphene material.

In some embodiments, the electrode material of the present application may further comprise 5-30 wt % of a binder, based on the functionalized graphene material. Without being bound to any theory, polytetrafluoroethylene is preferably used as the binder in the present application.

Another aspect of the present application relates to a capacitor comprising the electrode plate as disclosed in the present application. Particularly, the capacitor of the present application is made from the electrode material of the present application.

Certainly, the capacitor further comprises an electrolyte and a separator, which can be those commonly used in the art. For example, the electrolyte may be an inorganic or organic electrolyte. Examples of inorganic electrolytes include alkali metal solutions, such as a potassium hydroxide solution, a sulfuric acid solution. Examples of organic electrolytes are (including, but not limited to) N,N-dimethyl-N-ethyl-N-2-methoxyethylammonium di(trifluoromethyl sulfonyl) imine salt (DEMENTf₂).

Separators that may be used in the present application include hydrophilic porous separators and insulated porous separators.

Another aspect of the present application relates to a method for preparing an electrode material, comprising adhering a predetermined amount of a functionalized graphene material to an electrode substrate. In this aspect, powdered functionalized graphene material is preferably adhered to the electrode substrate.

In one preferred embodiment, the functionalized graphene material is directly pressed onto an electrode substrate or a prepared electrode plate.

In one embodiment, the functionalized graphene material powder is mixed with a predetermined amount of conductive carbon black, and the obtained mixture is then pressed onto the electrode substrate.

In some embodiments, the functionalized graphene material powder is mixed with a predetermined amount of a binder and/or conductive carbon black, then distilled water is added and the obtained mixture is stirred into slurry. The slurry is dried and pressed onto an electrode substrate after being made into powder.

The amount of the conductive carbon black or the binder depends on the actual demand. Generally, the conductive carbon black is 5-30 wt % of the added functionalized graphene material. The ratio in weight between the functionalized graphene material and the binder may be 90-95:5-10.

### EXAMPLES

### Preparing Examples

### Preparing Example 1

### Preparation of a Functionalized Graphene Material by Chemical Reduction

5 g of graphite, 3.8 g of NaNO₃ and then 370 mL of concentrated sulphuric acid were added into a three-neck flask. Then, with stirring in an ice-water bath, 23 g of KMnO₄ was slowly added. After stirring electrically for 7 days at room temperature, the reaction solution was slowly added into 500 mL of 5 wt % diluted sulphuric acid, and the temperature was kept at 98° C. The reaction solution was further stirred for 2 h at this temperature and then cooled to 60° C. 15 mL of H₂O₂ (30 wt % aqueous solution) was added, and the temperature was kept at 60° C. for 2 h. The solution was then cooled to room temperature, and the impurities therein were removed by centrifugation. The following procedure was repeated 10 times: centrifugating for 20 min at 8,000 rpm, removing the supernatant, then adding a mixture of 3 wt % H₂SO₄/0.5 wt % H₂O₂, and stirring vigorously for 30 min. After that, the above steps were repeated two times with 3 wt % hydrochloric acid, and two times with distilled water. Then the solvent was removed to yield a soluble graphene material.

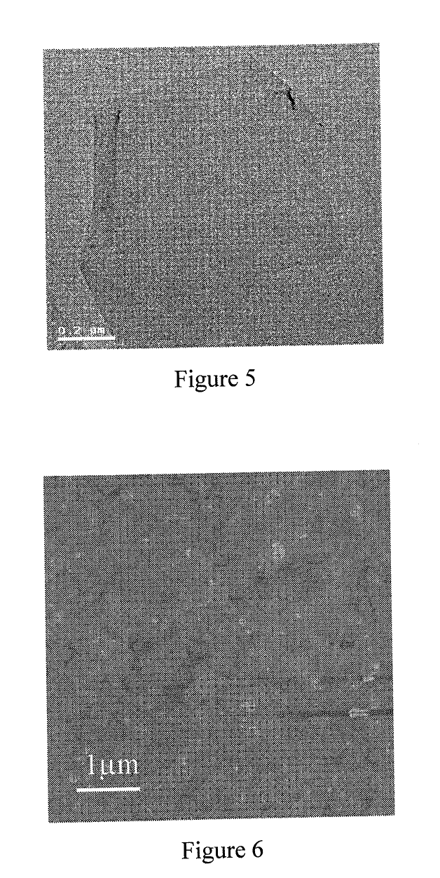

FIG. 5, a transmission electron microscope image of the soluble graphene of this preparing example, shows that the soluble single-layer graphite oxide is in the form of single layer.

FIG. 6 is an atomic force microscope image of the soluble graphene of this preparing example (1.0 mg/ml aqueous solution).

The dried 200 mg soluble graphene material obtained from the above steps was placed in a culture dish and put into a desiccator after being covered with a filter paper. Then 80% (by weight) hydrazine hydrate solution was dropwise added on the filter paper to reduce the graphene material. The desiccator was closed, and the reaction time was controlled to 72 h to obtain a chemically reduced functionalized graphene material.

The electrical conductivity was about 300 S/m as tested by the conventional four electrode test method.

### Preparing Example 2

### Preparation of Functionalized Graphene Material by Physical Reduction

The dried 200 mg soluble graphene material obtained from preparing example 1 was heated under argon atmosphere at a rate of 3° C./min, held at 400° C. for 3 h, and then allowed to natural cooling. The functionalized graphene material treated by physical reduction was obtained.

The electrical conductivity was about 400 S/m as tested by the conventional four electrode test method.

### Preparing Example 3

The chemically reduced functionalized graphene material obtained from preparing example 1 was further physically reduced: heated at a rate of 3° C./min, held at 400° C. for 3 h, and then allowed to natural cooling. The whole process was carried out under argon atmosphere. The functionalized graphene material treated by a combination of chemical reduction and physical reduction was obtained.

The electrical conductivity was about 600 S/m as tested by the conventional four electrode test method.

### Example 1

7 mg graphene material obtained from preparing example 1 was mixed with polytetrafluoroethylene (PTFE) in the weight ratio of 90:10. Distilled water was dropwise added. The mixture was stirred into slurry and then dried at lower temperature. The obtained solid powder was pressed onto a nickel foam current collector with a diameter of 1.3 cm (340 mg) (Changsha Liyuan New Material Co., Ltd., High-strength nickel foam with superhigh binding force, Pores per inch (PPI): 80-110; Thickness: 1.4-2.0 mm, similarly hereinafter) under a predetermined pressure (160 MPa) to produce a circular electrode plate with an area of about 1.3 cm².

Two electrode plates with similar weight were placed face to face and separated by a hydrophilic porous polypropylene separator (Tianjin Siteng Fiber S&T Development Co., Ltd., Siteng polypropylene modified hydrophilic fiber, similarly hereinafter). 30 wt % of KOH was dropwise added as an electrolyte. The supercapacitor of the present application was obtained after encapsulating the above components into a button cell shell.

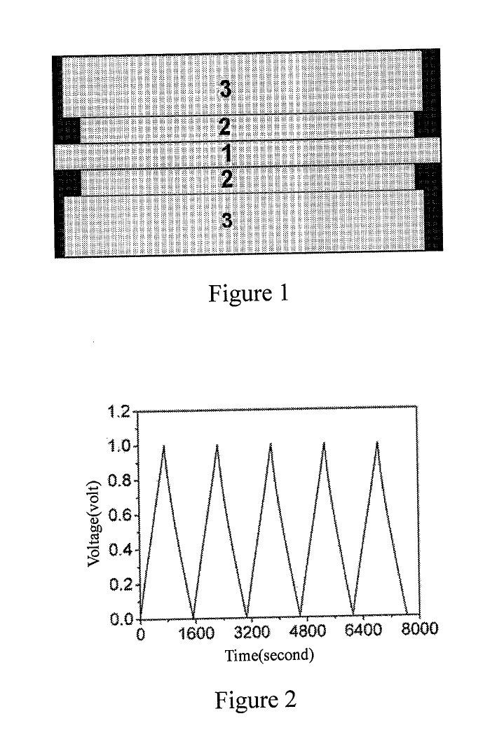

FIG. 1 shows the capacitor prepared according to the present application, wherein reference number 1 represents a hydrophilic porous separator, reference number 3 represents a nickel foam current collector, reference number 2 represents a a functionalized graphene material adhered to the nickel current collector. 2 and 3 constitute the electrode plates of the supercapacitor in the present application.

Referring to FIG. 2, there is shown a galvanostatic charge/discharge curve of the supercapacitor prepared in Example 1. At a constant current density of 100 mA/g, the graphene material underwent several cycles of charge and discharge. A process of charge and discharge occurs during each cycle. In addition, repeatability of the charge/discharge curve is good. Specific capacitance of the supercapacitor calculated from the slope of the galvanostatic charge/discharge curve is 200 F/g, and energy density is 28 Wh/kg. The slope of the galvanostatic charge/discharge curve is constant, without any significant variation, indicating that it is suitable for the graphene material to be used as an electrode material for a supercapacitor.

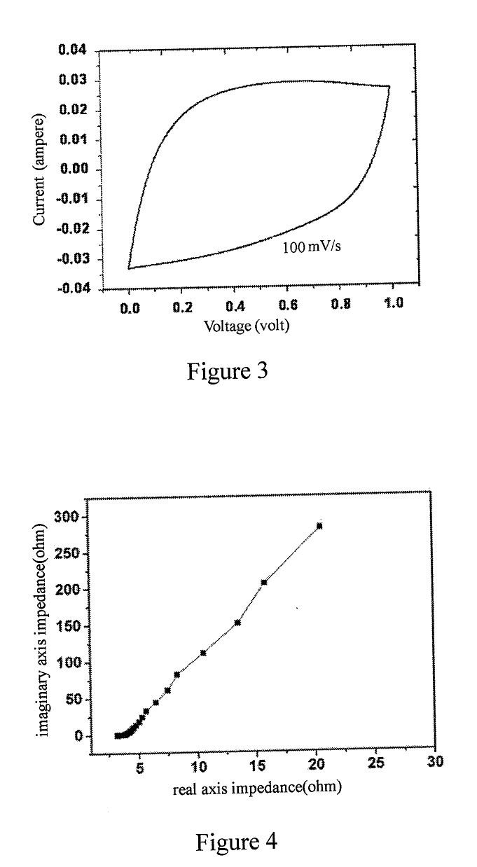

Referring to FIG. 3, there is shown a cyclic voltammetry curve of the supercapacitor prepared in Example 1.

At a scanning rate of 100 mV/s, the cyclic voltammetry curve maintains the shape of a rectangle, indicating that the graphene material is hard to be polarized, and is therefore suitable to be used as an electrode material for a supercapacitor.

FIG. 4 is an alternating current impedance test curve of the supercapacitor prepared in Example 1.

It can be seen that the resistance value of the supercapacitor obtained from the intersection of the alternating current impedance test curve at the X-axis is about 3.2 W, and the specific power value of the supercapacitor calculated thereby is up to 10.3 kW/kg.

### Example 2

After drying the chemically reduced functionalized graphene material obtained from preparing example 1 at low temperature, the obtained solid powder was pressed onto the nickel foam current collector with a diameter of 1.3 cm (Changsha Liyuan New Material Co., Ltd.) to produce a circular electrode plate. The functionalized graphene material is about 7 mg, and comprises about 2% by weight of the electrode plate.

Two electrode plates with similar weight were placed face to face and separated by a hydrophilic porous polypropylene separator (Tianjin Siteng Fiber S&T Development Co., Ltd.). 30 wt % of KOH was dropwise added as an electrolyte. The supercapacitor was obtained after encapsulating the above components into a button cell shell.

The specific capacitance of the supercapacitor prepared in the present example tested by a method similar to that of Example 1 is 180 F/g, the specific power is up to 18.3 kW/kg, and the energy density is up to 25 Wh/kg.

In view of the results of Example 1 and Example 2, addition of the binder polytetrafluoroethylene (PTFE) improved performance of the supercapacitor.

### Example 3

After drying the chemically reduced graphene material obtained from preparing example 1 at low temperature, the obtained solid powder was pressed onto the nickel foam current collector (Changsha Liyuan New Material Co., Ltd.) under a predetermined pressure (about 160 MPa, similarly hereinafter) to produce a circular electrode plate with a diameter of 1.3 cm. The functionalized graphene material is about 7 mg, and comprises 2 wt % of the whole electrode.

Two electrode plates with similar weight were placed face to face and separated by a hydrophilic porous polypropylene separator (Tianjin Siteng Fiber S&T Development Co., Ltd.). 5 wt % of KOH was dropwise added as an electrolyte. The supercapacitor was obtained after encapsulating the above components into a button cell shell.

The specific capacitance of the supercapacitor prepared in the present example tested by a method similar to that of Example 1 is 103 F/g, the specific power is up to 8 kW/kg, and the energy density is up to 14 Wh/kg.

### Example 4

After drying the chemically reduced functionalized graphene material obtained from preparing example 1 at low temperature, the resultant solid powder was pressed onto the platinum current collector (Tianjin AidaHengsheng Technology Ltd Co., platinum sheet thickness: 0.1-0.5 mm, platinum purity: 99.95% or more, similarly hereinafter) to produce a circular electrode plate with a diameter of 1.3 cm. The functionalized graphene material is about 7 mg, and comprises 3% by weight of the whole electrode plate.

Two electrode plates with similar weight were placed face to face and separated by a hydrophilic porous separator (Nanjing Fiberglass Research & Design Institute, Fiberglass separator sheets for lithium cells, similarly hereinafter). 5 wt % of H₂SO₄ was dropwise added as an electrolyte. The supercapacitor of the present application was obtained after encapsulating the above components into a button cell shell.

The specific capacitance of the supercapacitor prepared in the present example tested by the method similar to that of Example 1 is 97 F/g, the specific power is up to 9 kW/kg, and the energy density is up to 13 Wh/kg.

### Example 5

After drying the chemically reduced functionalized graphene material obtained from preparing example 1 at low temperature, the resultant solid powder was pressed onto a platinum current collector (Tianjin AidaHengsheng Technology Ltd Co.) to produce a circular electrode plate with a diameter of 1.3 cm. The functionalized graphene material is about 7 mg, and comprises 3% by weight of the whole electrode plate.

Two electrode plates with similar weight were placed face to face and separated by a hydrophilic porous separator (Nanjing Fiberglass Research & Design Institute). 30 wt % of H₂SO₄ was dropwise added as an electrolyte. The supercapacitor of the present application was obtained after encapsulating the above components into a button cell shell.

The specific capacitance of the supercapacitor prepared in the present example tested by a method similar to that of Example 1 is 160 F/g, the specific power is up to 14 kW/kg, and the energy density is up to 22 Wh/kg.

### Example 6

5 wt % of conductive carbon black and 10 wt % of PTFE, based on weight of the functionalized graphene material were added into the chemically reduced functionalized graphene material obtained from preparing example 1. The mixture was mixed by the mixing method as described in Example 2. After drying at low temperature, the resultant solid powder was pressed onto the nickel foam current collector (Changsha Liyuan New Material Co., Ltd.) to produce a circular electrode plate with a diameter of 1.3 cm. The functionalized graphene material is about 15 mg, and comprises 2% by weight of the whole electrode plate.

Two electrode plates with similar weight were placed face to face and separated by a hydrophilic porous separator (Tianjin Siteng Fiber S&T Development Co., Ltd.). 30 wt % of KOH was dropwise added as an electrolyte. The supercapacitor was obtained after encapsulating the above components into a button cell shell.

The specific capacitance of the supercapacitor prepared in the present example tested by a method similar to that of Example 1 is 130 F/g, the specific power is up to 10 kW/kg, and the energy density is up to 18 Wh/kg.

### Example 7

5 wt % of conductive carbon black and 10 wt % of PTFE, based on weight of the functionalized graphene material were added into the chemically reduced functionalized graphene material obtained from preparing example 1. The mixture was mixed by the mixing method as described in Example 1. After drying at low temperature, the resultant solid powder was pressed onto a platinum current collector (Tianjin AidaHengsheng Technology Ltd Co.) to produce a circular electrode plate with a diameter of 1.3 cm. The functionalized graphene material is about 15 mg, and comprises 3% by weight of the whole electrode plate.

Two electrode plates with similar weight were placed face to face and separated by a hydrophilic porous separator (Nanjing Fiberglass Research & Design Institute). 30 wt % of H₂SO₄ was dropwise added as an electrolyte. The supercapacitor of the present application was obtained after encapsulating the above components into a button cell shell.

The specific capacitance of the supercapacitor prepared in the present example tested by a method similar to that of Example 1 is 143 F/g, the specific power is up to 14 kW/kg, and the energy density is up to 20 Wh/kg.

### Example 8

The physically reduced functionalized graphene material obtained from preparing example 2 was pressed onto the nickel foam current collector (Changsha Liyuan New Material Co., Ltd.) to produce a circular electrode plate with a diameter of 1.3 cm. The functionalized graphene material is about 7 mg, and comprises 2% by weight of the whole electrode.

Two electrode plates with similar weight were placed face to face and separated by a hydrophilic porous separator (Tianjin Siteng Fiber S&T Development Co., Ltd.). 30 wt % of KOH was dropwise added as an electrolyte. The supercapacitor of the present application was obtained after encapsulating the above components into a button cell shell.

The specific capacitance of the supercapacitor prepared in the present example tested by a method similar to that of Example 1 is 63 F/g, the specific power is up to 6 kW/kg, and the energy density is up to 9 Wh/kg.

### Example 9

The functionalized graphene material obtained by a combination of chemical reduction and physical reduction in preparing example 3 was mixed with the binder polytetrafluoroethylene in the ratio in weight of 95:5. Distilled water was dropwise added, and the above mixture was mixed into slurry. After drying at low temperature, the resultant solid powder was pressed onto a nickel foam current collector (Changsha Liyuan New Material Co., Ltd.) to produce a circular electrode plate with a diameter of 1.3 cm. The functionalized graphene material is about 7 mg, and comprises 2% by weight of the whole electrode plate.

Two electrode plates with similar weight were placed face to face and separated by a hydrophilic porous separator (Tianjin Siteng Fiber S&T Development Co., Ltd.). 30 wt % of KOH was dropwise added as an electrolyte. The supercapacitor of the present application was obtained after encapsulating the above components into a button cell shell.

The specific capacitance of the supercapacitor prepared in the present example tested by a method similar to that of Example 1 is 70 F/g, the specific power is up to 7 kW/kg, and the energy density is up to 10 Wh/kg.

### Example 10

The functionalized graphene material obtained by a combination of chemical reduction and physical reduction in preparing example 3 was mixed with the binder polytetrafluoroethylene in the ratio in weight of 95:5. Distilled water was dropwise added, and the above mixture was mixed into slurry. After drying at low temperature, the resultant solid powder was pressed onto a platinum current collector (Tianjin AidaHengsheng Technology Ltd Co.) to produce a circular electrode plate with a diameter of 1.3 cm. The functionalized graphene material is about 7 mg, and comprises 3% by weight of the whole electrode plate.

Two electrode plates with similar weight were placed face to face and separated by a hydrophilic porous separator (Nanjing Fiberglass Research & Design Institute). 30 wt % of H₂SO₄ was dropwise added as an electrolyte. The supercapacitor of the present application was obtained after encapsulating the above components into a button cell shell.

The specific capacitance of the supercapacitor prepared in the present example tested by a method similar to that of Example 1 is 60 F/g, the specific power is up to 6 kW/kg, and the energy density is up to 8 Wh/kg.

### Example 11

After drying chemically reduced functionalized graphene material obtained from preparing example 1 at low temperature, the resultant solid powder was pressed onto an aluminium current collector (Shanghai Aluminum Products Co., Ltd., Model: 1100) at a predetermined pressure to produce a circular electrode plate with a diameter of 1.3 cm. The functionalized graphene material is about 15 mg, and comprises 20% by weight of the whole electrode.

Two electrode plates with similar weight were placed face to face and separated by an insulated porous separator (Japanese NKK Industry Co., Ltd., paper separator TF4035), and N,N-dimethyl-N-ethyl-N-2-methoxyethyl ammonium di(trifluoromethylsulfonyl) imine salt (DEMENTf₂) was used as an electrolyte. The supercapacitor of the present application was obtained after encapsulating the above components into a button cell shell.

The specific capacitance of the supercapacitor prepared in the present example tested by a method similar to that of Example 1 is 52 F/g, the specific power is up to 35 kW/kg, and the energy density is up to 40 Wh/kg.

1. An electrode material, comprising a functionalized graphene material and an electrode substrate, wherein the electrode material comprises the functionalized graphene material of 0.5-50%, preferably 1-40%, more preferably 2-30%, most preferably 2-20%, based on the total weight of the electrode material.

2. The electrode material according to claim 1, wherein the functionalized graphene material is adhered to the electrode substrate.

3. The electrode material according to claim 1, further comprising 5-30 wt % of conductive carbon black and/or 5-30 wt % of a binder, based on the functionalized graphene material.

4. The electrode material according to claim 3, wherein the binder is polytetrafluoroethylene.

5. The electrode material according to claim 1, wherein the electrode material is an electrode plate.

6. A capacitor, comprising an electrode plate, wherein the electrode plate is made from the electrode material according to claim 1.

7. The capacitor according to claim 6, further comprising an electrolyte and a separator.

8. The capacitor according to claim 7, wherein the electrolyte comprises a potassium hydroxide electrolyte, a sulfuric acid electrolyte or N,N-dimethyl-N-ethyl-N-2-methoxyethyl ammonium di(trifluoromethylsulfonyl) imine salt (DEMENTf₂).

9. The capacitor according to claim 7, wherein the electrolyte comprises 5-30 wt % of a potassium hydroxide electrolyte, 5-30 wt % of a sulfuric acid electrolyte or N,N-dimethyl-N-ethyl-N-2-methoxyethyl ammonium di(trifluoromethylsulfonyl) imine salt (DEMENTf₂).

10. The capacitor according to claim 7, wherein the electrolyte comprises 30 wt % of a KOH electrolyte or 30 wt % of a sulfuric acid electrolyte.

11. The capacitor according to claim 7, wherein the separator is a hydrophilic porous separator or an insulated porous separator.

12. The capacitor according to claim 6, comprising two electrodes.

13. A method for preparing an electrode material, comprising adhering a predetermined amount of a functionalized graphene material to an electrode substrate.

14. The method according to claim 13, further comprising:
mixing the functionalized graphene material with a binder and/or conductive carbon black; and
adhering the obtained solid mixture to the electrode substrate.

15. The method according to claim 14, wherein the ratio between the conductive carbon black or the binder such as polytetrafluoroethylene and the functionalized graphene material is 5-30 wt %.

16. The method according to claim 14, wherein the ratio in weight between the functionalized graphene material and the binder is 90-95:5-10.

17. The method according to claim 13, wherein the functionalized graphene material powder is pressed onto the electrode substrate.

18. A method of improving performance of an electrode in a capacitor, comprising adhering a predetermined amount of functionalized graphene material to the electrode.

19. The method according to claim 18, comprising:
mixing the functionalized graphene material with a binder such as polytetrafluoroethylene and/or conductive carbon black; and
adhering the obtained mixed solid powder to the electrode.

20. The method according to claim 18 or 19, wherein the adhering is pressing.

21-23. (canceled)
